(19) United States
(12) Patent Application Publication
(10) Pub. No.: US 2024/0418459 A1
(43) Pub. Date: Dec. 19, 2024

(54) LATTICE STRUCTURES

(71) Applicant: HEWLETT-PACKARD DEVELOPMENT COMPANY, L.P., Spring, TX (US)

(72) Inventors: Wei HUANG, Palo Alto, CA (US); Thomas Craig ANTHONY, Palo Alto, CA (US); Harish IRRINKI, Vancouver, WA (US); Ben PON, Palo Alto, CA (US)

(73) Assignee: HEWLETT-PACKARD DEVELOPMENT COMPANY, L.P., Spring, TX (US)

(21) Appl. No.: 18/704,249

(22) PCT Filed: Oct. 27, 2021
(86) PCT No.: PCT/US2021/056817

§ 371 Date: Apr. 24, 2024

(51) Int. Cl. F28F 13/12; B22F 10/47; B33Y 30/00; B33Y 50/00; B33Y 80/00

(52) U.S. Cl. CPC F28F 13/12; B22F 10/47; B33Y 50/00; B33Y 80/00; B33Y 30/00

(57) ABSTRACT

Examples of lattice structures are described herein. In some examples, a heat exchanger may include a three-dimensional (3D) lattice structure. In some examples, the heat exchanger may include a spiral structure transecting the 3D lattice structure. In some examples, the spiral structure is to mix fluid to pass through the 3D lattice structure.

### BACKGROUND

Some operations produce heat. For example, computing device processors generate heat as transistors switch to execute instructions. Light emitting diodes (LEDs) produce heat while converting an electrical current into light. Batteries produce heat during charging and discharging due to internal resistance. Vehicle engines produce heat as fuel combusts. In some examples, heat and/or overheating may damage a device and/or may cause inefficient operation.

### BRIEF DESCRIPTION OF THE DRAWINGS

FIG. 1 is a diagram illustrating an example of a structure including a three-dimensional (3D) lattice structure;

FIG. 2 is a diagram illustrating a top interior view of an example of a heat exchanger;

FIG. 3 is a block diagram of an example of an apparatus that may be used to manufacture a structure or structures described herein; and

FIG. 4 is a flow diagram illustrating an example of a method for manufacturing a structure.

### DETAILED DESCRIPTION

A heat exchanger is a device to transfer heat between mediums. For instance, a heat exchanger may be utilized to transfer heat from a heat source (e.g., processor, LED, combustion engine, battery, boiler, etc.) to a substance (e.g., fluid, water, air, etc.). In some examples, a heat exchanger may be utilized to cool a processor, engine, an LED light bulb, battery, etc.

In some approaches, a heat exchanger may transfer heat to a fluid flowing through a channel of the heat exchanger. In some examples, the fluid may exhibit a laminar flow with little or no mixing of the fluid, which may reduce and/or limit the amount of heat absorbed by the fluid. For instance, hotter fluid may remain localized near the hot surface and colder fluid near the cold surface, which may limit cooling performance. This deficiency may arise due to limitations of some manufacturing approaches such as computer numerical controller (CNC) milling, metal injection molding, skived fins, and/or casting. 3D printing may be utilized to manufacture heat transfer devices with enhanced performance.

Some examples of the techniques described herein may provide heat exchangers that include lattice structures to transfer heat. For instance, a heat exchanger may include a channel with a lattice structure, where the lattice structure serves to transfer heat from a body of the heat exchanger to fluid flowing through the channel.

A lattice structure is an arrangement of a member or members (e.g., branches, beams, joists, columns, posts, rods, fins, etc.). For example, a lattice structure may be structured along one dimension, two dimensions, and/or three dimensions. Examples of a lattice structure may include rods, two-dimensional grids, three-dimensional grids, etc. In some examples, a lattice structure includes members disposed in a crosswise manner. For instance, two members of a lattice structure may intersect at a diagonal, perpendicular, or oblique (e.g., non-perpendicular and non-parallel) angle.

Some examples of the structures described herein may include combinations of lattice structures with flow exchange structures (e.g., spiral structures, helical structures, mixing structures, etc.). In some examples, a lattice and another structure may form a multiscale heat transfer structure for enhanced flow exchange and cooling performance. For instance, a cooling lattice structure at a smaller scale may be integrated with a structure for flow exchange at a larger scale. In some examples, the structures for flow exchange may be relatively thin to avoid significantly changing a filling space of the lattice structures. Because the flow exchange structures may increase fluid exchange between colder and hotter fluids, cooling performance may be enhanced compared to other approaches without flow exchange structures.

In some examples, a lattice structure, flow exchange structure, and/or heat exchanger may be manufactured by three-dimensional (3D) printing. Some examples of 3D printing that may be utilized to manufacture some examples of the structures described herein may include Fused Deposition Modeling (FDM), Multi-Jet Fusion (MJF), Selective Laser Sintering (SLS), binder jet, Stereolithography (SLA), Selective Laser Melting (SLM), Electron Beam Melting (EBM), Metal Jet Fusion, metal binding printing, liquid resin-based printing, etc.

In some examples, additive manufacturing may be used to manufacture 3D objects (e.g., geometries, lattices, etc.). Some examples of additive manufacturing may be achieved with 3D printing. For example, thermal energy may be projected over material in a build area, where a phase change and solidification in the material may occur at certain voxels. A voxel is a representation of a location in a 3D space (e.g., a component of a 3D space). For instance, a voxel may represent a volume that is a subset of the 3D space. In some examples, voxels may be arranged on a 3D grid. For instance, a voxel may be cuboid or rectangular prismatic in shape. In some examples, voxels in the 3D space may be uniformly sized or non-uniformly sized. Examples of a voxel size dimension may include 25.4 millimeters (mm)/150≈170 microns for 150 dots per inch (dpi), 490 microns for 50 dpi, 2 mm, 4 mm, etc. The term “voxel level” and variations thereof may refer to a resolution, scale, or density corresponding to voxel size.

Some examples of the geometries and/or structures (e.g., lattice structures, flow exchange structures, etc.) described herein may be produced by additive manufacturing. For instance, some examples may be manufactured with plastics, polymers, semi-crystalline materials, metals, etc. Some additive manufacturing techniques may be powder-based and driven by powder fusion. Some examples of the geometries and/or structures (e.g., lattices) described herein may be manufactured with area-based powder bed fusion-based additive manufacturing, such as MJF, Metal Jet Fusion, metal binding printing, SLM, SLS, etc. Some examples of the approaches described herein may be applied to additive manufacturing where agents carried by droplets are utilized for voxel-level thermal modulation.

In some examples of additive manufacturing, thermal energy may be utilized to fuse material (e.g., particles, powder, etc.) to form an object (e.g., structure, geometry, lattice, etc.). For example, agents (e.g., fusing agent, detailing agent, etc.) may be selectively deposited to control voxel-level energy deposition, which may trigger a phase change and/or solidification for selected voxels.

In some examples of 3D printing, a binding agent (e.g., adhesive) may be printed onto material in a build volume to bind powder (e.g., particles) a form a precursor object (e.g., “green part”). The precursor object may be heated (in an oven or heating apparatus, for example) to sinter the precursor object and form a solid part.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

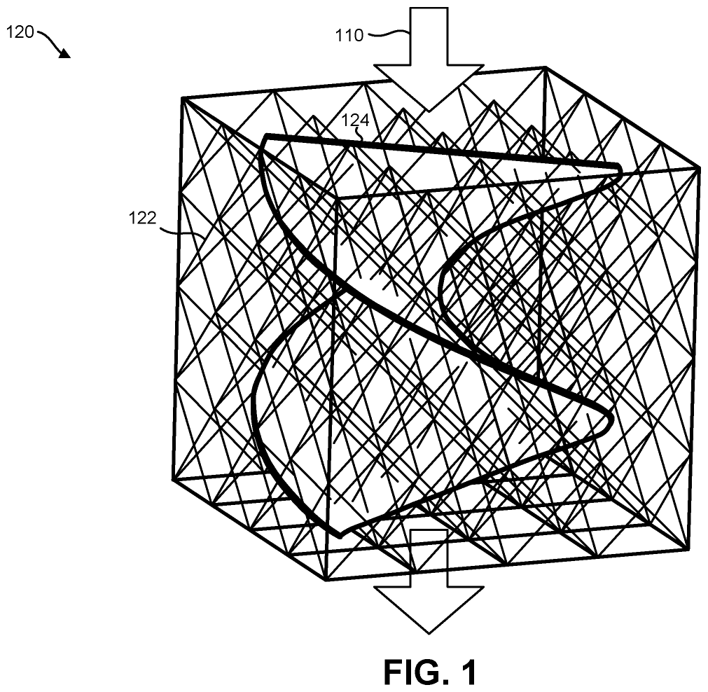

FIG. 1 is a diagram illustrating an example of a structure 120 including a 3D lattice structure 122. In some examples, the structure 120 may be a heat exchanger and/or may be included in a heat exchanger. In this example, the 3D lattice structure 122 includes members (e.g., beams) that intersect at a diagonal, perpendicular, or oblique (e.g., non-perpendicular and non-parallel) angle. In the example of FIG. 1, the members of the 3D lattice structure 122 intersect at 90° angles. In other examples, the members of a lattice may intersect at a different angle or angles (e.g., 15°, 30°, 45°, 70°, 85°, 95°, 110°, 135°, etc.).

In some examples, the 3D lattice structure 122 may be disposed within a housing. For instance, the 3D lattice structure 122 may be included within a housing and/or may span between boundaries of the housing. In some examples, the housing may be circular (e.g., tubular), rectangular, irregularly shaped, or a combination thereof.

In some examples, the 3D lattice structure 122 may be disposed within a channel. For instance, the 3D lattice structure 122 may partially or fully span a channel. In some examples, the channel may be circular (e.g., tubular), rectangular, irregularly shaped, or a combination thereof. In some examples, a housing may provide a wall or walls that contain the channel. In some examples, a channel may be utilized to conduct fluid (e.g., water, coolant, air, etc.).

An example of a flow direction 110 is illustrated in FIG. 1. In some examples, the lattice structure 122 may permit fluid flow. For instance, a fluid may flow through the lattice structure 122 (e.g., through spaces between members of the lattice structure 122). In some examples, the structure 120 may be a single-flow heat exchanger or may be included in a single-flow heat exchanger. For instance, a heat source may be placed in contact with a heat exchanger (e.g., with a housing wall(s) of the structure 120). The heat may be conducted through the lattice structure 122. Fluid flowing through the lattice structure 122 may absorb the heat from the lattice structure 122. Accordingly, the heat source may dissipate heat to the lattice structure 122, which may cool the heat source.

The structure 120 may include a spiral structure 124. The spiral structure 124 may have a twisting or coiling shape along an axial direction. For instance, the spiral structure 124 may be helical in shape, where the helix structurally repeats along a dimension. A “spiral structure” may be continuous or segmented. For instance, a spiral structure may include a set of fins or guides arranged in a helical pattern. In some examples, a spiral structure may conform to a flow direction. For instance, a spiral structure may have a counterclockwise helix (or clockwise helix in some examples) in a flow direction or along a spiral axis. While an example of a spiral structure 124 is shown in FIG. 1, other shapes may be utilized in some examples.

The spiral structure 124 may transect the 3D lattice structure 122. For instance, the spiral structure 124 through a member or members of the 3D lattice structure 122. In some examples, the spiral structure 124 may transect the 3D lattice structure 122 by being attached along a span or spans of the 3D lattice structure 122. In some examples, the spiral structure 124 may transect the 3D lattice structure 122 by being geometrically merged with the 3D lattice structure 122. For instance, the spiral structure 124 may overlap with the 3D lattice structure 122 within a volume. In some examples, the spiral structure 124 may transect the 3D lattice structure 122 by forming a geometric (e.g., voxel) union between the spiral structure 124 and the 3D lattice structure 122. In some examples, forming a geometric union may be accomplished using a Boolean operation. For instance, a “Boolean operation” may refer to a union operation, where multiple (e.g., two) models are united into a single model topologically. In some examples, a Boolean operation may be performed on models represented in an STL file(s) to produce a geometric union between the models.

In some examples, the spiral structure 124 may be disposed to mix fluid that is to pass through the 3D lattice structure 122. For instance, the spiral structure 124 may mix fluid as the fluid passes through the 3D lattice structure 122. In some examples, the spiral structure 124 may mix fluid by disrupting a direct flow and/or by guiding the fluid to change from a direct axial (e.g., laminar) flow along a flow direction. For instance, a heat source may be placed along a left side of the structure 120 illustrated in FIG. 1. The spiral structure 124 may guide fluid that is being heated on the left side to the right side of the structure 120 (and vice versa, for instance), thereby mixing and/or exchanging fluid (between hotter and cooler regions of the structure 120, for instance).

In some examples, the 3D lattice structure 122 repeats in multiple directions and the spiral structure 124 repeats in one direction. In some examples, a lattice structure may repeat in two dimensions or three dimensions. A repeating structure may have the same or a similar shape(s) repeating spatially. For instance, the lattice structure 122 illustrated in FIG. 1 repeats in three dimensions (e.g., along x, y, and z axes). In some examples, the spiral structure 124 may repeat in one direction. For instance, the spiral structure 124 spatially recurs over an axial dimension (e.g., over a distance or length) of the spiral structure 124.

In some examples, a first scale of the spiral structure 124 may be different from a second scale of the 3D lattice structure 122. For instance, the first scale may be larger than the second scale or the second scale may be larger than the first scale. A scale may refer to a size and/or spatial repetition of a structure. For instance, a first scale of the spiral structure 124 may refer to a spatial repetition distance and/or a dimension (e.g., x, y, or z dimension) of the spiral structure 124. A second scale of the 3D lattice structure 122 may refer to a spatial repetition distance (e.g., the size of one recurring cell) and/or a dimension (e.g., x, y, or z dimension) of a cell. For instance, a first scale of the spiral structure 124 may be 1 inch (e.g., 1 inch between spatial repetitions of the helical structure) and a second scale of the 3D lattice structure 122 may be 0.25 inches (e.g., 0.25 inches between spatial repetitions of the lattice structure and/or of a cuboid cell, etc.). In some examples, other sizes may be utilized.

In some examples, multiple flow exchange structures (e.g., spiral structures) may transect a lattices structure and/or may be included in a heat exchanger. For instance, a second spiral structure may transect a 3D lattice structure. In some examples, the second spiral structure may be disposed adjacent to (e.g., approximately axially parallel to) a first spiral structure in a channel of a heat exchanger. Other quantities of flow exchange structures may be utilized in some examples.

In some examples, the 3D lattice structure 122 and the spiral structure are manufactured concurrently (e.g., in overlapping periods) via 3D printing. For instance, the 3D lattice structure 122 and the spiral structure 124 may be printed concurrently (e.g., in the same build). In some examples, the 3D lattice structure 122 may support the spiral structure 124 during manufacturing. For instance, the 3D lattice structure 122 may perform two functions: manufacturing support and heat dissipation. In some examples, the 3D lattice structure 122 may be a non-sacrificial support to the spiral structure 124. For instance, the 3D lattice structure 122 may be maintained (e.g., not removed) after manufacturing. In some examples, the spiral structure 124 may be perforated to facilitate removal of unprinted material. After printing, for instance, a perforation(s) in the spiral structure 124 may allow for the passage of air (e.g., for vacuuming, for air blasting, etc.) for powder removal.

In some examples, the 3D lattice structure 122 and the spiral structure 124 are a monolithic body. For instance, the 3D lattice structure 122 and the spiral structure 124 may have a same or similar material composition.

In the example of FIG. 1, a larger-scale spiral structure 122 is incorporated into a smaller-scale lattice structure 124 to cycle fluid between hot and cold sides of the structure 120 as fluid flows along the axis of the spiral structure 124. In some examples, cooling structures (e.g., the 3D lattice structure 122) at smaller scales may be integrated with larger-scale structures (e.g., the spiral structure 124) for flow exchange using Boolean operations. A larger-scale structure may be utilized to guide the global flow direction, while a smaller-scale cooling structure may be utilized for local flow paths. Because the spiral structure 124 increases the exchange between colder and hotter fluids, cooling performance may be enhanced.

In some examples, the structure 120 may be utilized to transfer (e.g., absorb or dissipate) heat. For instance, the structure 120 may be included within, mounted to, and/or disposed in contact with a heat source. For instance, the structure 120 (e.g., a housing wall of the structure 120) may be placed in contact with a processor, engine, LED lamp, lithium battery, computing device housing, and/or other heat source, etc., to cool the heat source. For instance, the structure 120 may be included in a processor liquid cooler. In some examples, the structure 120 may receive heated liquid and may cool the liquid (e.g., dissipate heat from the liquid). In some examples, the structure 120 may provide enhanced cooling and/or may occupy less space than other cooling structures (e.g., heat sinks).

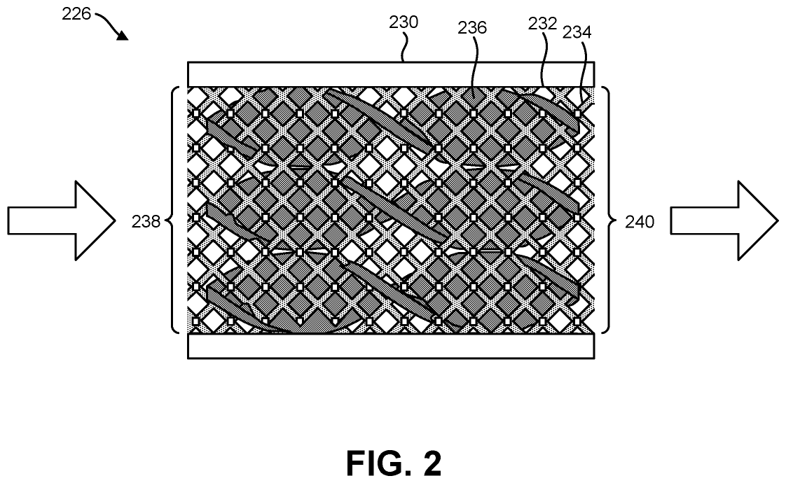

FIG. 2 is a diagram illustrating a top interior view of an example of a heat exchanger 226. The heat exchanger 226 may be an example of the structure 120 described in relation to FIG. 1. In this example, the heat exchanger 226 includes a housing 230, channel 232, 3D lattice structure 234, multiple spiral structures 236, an input 238, and an output 240. The heat exchanger 226 may be arranged in a cold plate design, where a heat source may be placed on top of the heat exchanger 226 and/or underneath the heat exchanger 226.

In this example, fluid may flow into the heat exchanger 226 via the input 238, through the 3D lattice structure 234 along three spiral structures, and out of the heat exchanger 226 via the outlet 240. Accordingly, the fluid may flow through the lattice structure 234 of the heat exchanger 226 while being repeatedly exchanged between a top and bottom of the heat exchanger 226. For instance, the flow may continuously switch between the top and bottom of the cold plate. As a result, when the heat source is applied to the top or the bottom surface of the cold plate, cooling performance may be improved without significantly affecting a pressure drop.

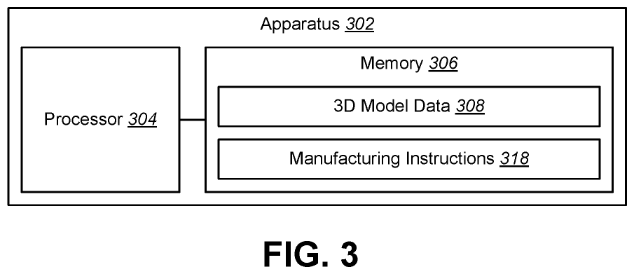

FIG. 3 is a block diagram of an example of an apparatus 302 that may be used to manufacture a structure or structures described herein. The apparatus 302 may be a computing device, such as a personal computer, a server computer, a printer, a 3D printer, a smartphone, a tablet computer, etc. The apparatus 302 may include and/or may be coupled to a processor 304 and/or to a memory 306. The processor 304 may be in electronic communication with the memory 306. In some examples, the apparatus 302 may be in communication with (e.g., coupled to, have a communication link with) a manufacturing device (e.g., a 3D printing device). In some examples, the apparatus 302 may be an example of a 3D printing device. The apparatus 302 may include additional components (not shown) and/or some of the components described herein may be removed and/or modified without departing from the scope of this disclosure.

The processor 304 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions (e.g., manufacturing instructions 318) stored in the memory 306. In some examples, the processor 304 may include an electronic circuit or circuits that include electronic components for performing a functionality or functionalities of the instructions (e.g., manufacturing instructions 318). In some examples, the processor 304 may be utilized to manufacture one, some, or all of the structures described in relation to one, some, or all of FIGS. 1-2.

The memory 306 may be any electronic, magnetic, optical, or other physical storage device that contains or stores electronic information (e.g., instructions and/or data). Thus, the memory 306 may be, for example, Random Access Memory (RAM), Electrically Erasable Programmable Read-Only Memory (EEPROM), a storage device, an optical disc, and the like. In some implementations, the memory 306 may be a non-transitory tangible machine-readable storage medium, where the term “non-transitory” does not encompass transitory propagating signals.

In some examples, the apparatus 302 may also include a data store (not shown) on which the processor 304 may store information. The data store may be volatile and/or non-volatile memory, such as Dynamic Random-Access Memory (DRAM), EEPROM, magnetoresistive random-access memory (MRAM), phase change RAM (PCRAM), memristor, flash memory, and the like. In some examples, the memory 306 may be included in the data store. In some examples, the memory 306 may be separate from the data store. In some approaches, the data store may store similar instructions and/or data as that stored by the memory 306. For example, the data store may be non-volatile memory and the memory 306 may be volatile memory.

In some examples, the apparatus 302 may include an input/output interface (not shown) through which the processor 304 may communicate with an external device or devices (not shown), for instance, to receive and/or store information pertaining to an object or objects (e.g., geometry (ies), lattice(s), flow exchange structure(s), etc.) to be manufactured. The input/output interface may include hardware and/or machine-readable instructions to enable the processor 304 to communicate with the external device or devices. The input/output interface may enable a wired and/or wireless connection to the external device or devices. In some examples, the input/output interface may further include a network interface card and/or may also include hardware and/or machine-readable instructions to enable the processor 304 to communicate with various input and/or output devices. Examples of input devices may include a keyboard, a mouse, a display, another apparatus, electronic device, computing device, etc., through which a user may input instructions into the apparatus 302. In some examples, the apparatus 302 may receive 3D model data 308 from an external device or devices (e.g., 3D scanner, removable storage, network device, etc.).

In some examples, the memory 306 may store 3D model data 308. The 3D model data 308 may be generated by the apparatus 302 and/or received from another device. Some examples of 3D model data 308 include a 3MF file or files, a CAD file, object shape data, mesh data, geometry data, etc. The 3D model data 308 may indicate the shape of an object or objects. For instance, the 3D model data 308 may indicate the shape of a geometry or geometries (e.g., regular and/or irregular geometries), a lattice structure or structures, and/or a flow exchange structure or structures for manufacture. In some examples, the 3D model data 308 may indicate a shape of one, some, or all of the geometry (ies), lattice(s), flow exchange structure(s), spiral structure(s), heat exchanger(s), etc., described herein.

In some examples, the processor 304 may execute the manufacturing instructions 318 to control a printhead to print a 3D lattice structure. In some examples, the processor 304 may control a printhead and/or may send instructions to a 3D printer to print the 3D lattice structure.

In some examples, the processor 304 may execute the manufacturing instructions 318 to control the printhead to print a flow exchange structure transecting the 3D lattice structure, where the flow exchange structure is to mix fluid to pass through the 3D lattice structure.

In some examples, the 3D lattice structure and the flow exchange structure are printed concurrently. For instance, the 3D lattice structure and the flow exchange structure may be printed concurrently as described in relation to FIG. 1.

In some examples, the 3D lattice structure may support the flow exchange structure during sintering. For instance, the 3D lattice structure may support the flow exchange structure as described in relation to FIG. 1. In some examples of metal 3D printing, for instance, the 3D lattice structure and the flow exchange structure may be printed as precursor objects and then sintered to join the metal particles and burn off the binding agent. During sintering, some structures may be prone to deformation, gravity slump, etc. In some examples of the techniques described herein, the 3D lattice structure may support the flow exchange structure during sintering to reduce deformation and/or enhance object manufacturing accuracy. In some examples of oven sintering, the 3D lattice structure may reduce (e.g., prevent) sagging in the flow exchange structure due to gravity. In some examples of laser sintering (e.g., SLM, EBM, etc.), the 3D lattice structure may reduce (e.g., prevent) deformation in the flow exchange structure due to residue stress.

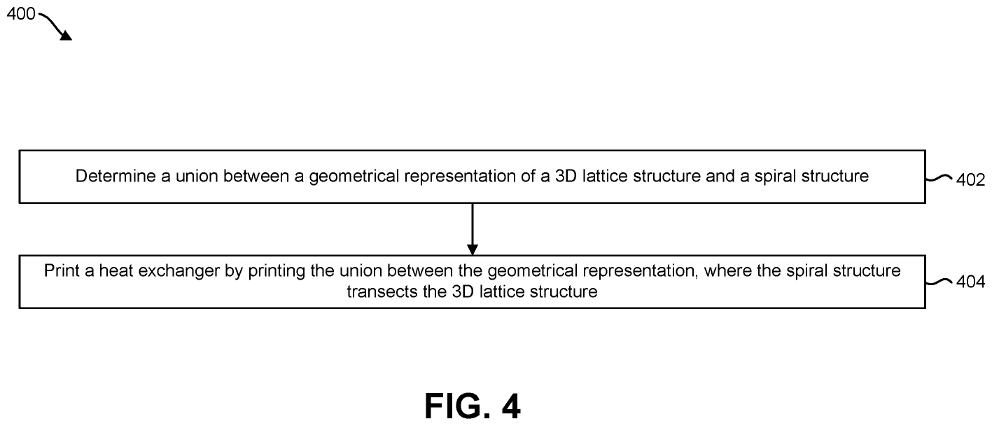

FIG. 4 is a flow diagram illustrating an example of a method 400 for manufacturing a structure. The method 400 and/or an element or elements of the method 400 may be performed by an apparatus (e.g., electronic device). For example, the method 400 may be performed by the apparatus 302 described in relation to FIG. 3.

The apparatus may determine 402 a union between a geometrical representation of a 3D lattice structure and a spiral structure. For example, the apparatus may store 3D model data representing a 3D lattice structure and 3D model data representing a spiral structure (or other flow exchange structure, for instance). In some examples, the apparatus may determine 402 the union by determining a combination of the 3D lattice structure and the spiral structure in 3D space. In some examples, first data representing the 3D lattice structure may be a set of voxels in 3D space, where voxels occupied by the 3D lattice structure are labeled (e.g., labeled with a ‘1’). Second data representing the spiral structure may be a set of voxels in 3D space, where voxels occupied by the spiral structure are labeled (e.g., labeled with a ‘1’). Non-occupied voxels may also be indicated (e.g., labeled with a ‘0’). In some examples, the union between the geometrical representation of the 3D lattice structure and the spiral structure may be determined by performing a voxel-wise OR operation between the first data and the second data. The resulting voxels labeled as occupied (e.g., with a ‘1’) may indicate the union between the geometrical representation of the 3D lattice structure and the spiral structure.

The apparatus may print 404 a heat exchanger by printing the union between the geometrical representation of the 3D lattice structure and the spiral structure (or other flow exchange structure, for instance), where the spiral structure transects the 3D lattice structure. For instance, the apparatus may be a 3D printer and/or may send instructions to a 3D printer to print the 3D lattice structure and the spiral structure. In some examples, the apparatus may utilize a geometrical model (e.g., computer-aided design (CAD) file(s), 3D manufacturing format (3MF) file(s), etc.) that specifies the shape (e.g., mesh, voxels, etc.) of the union. For example, the apparatus may control a printhead to print the 3D lattice structure and the spiral structure according to the voxels representing the union between the geometrical representation of the 3D lattice structure and the spiral structure. In some approaches (e.g., MJF), the union may be printed with fusing agent and fused using a thermal lamp to solidify the 3D lattice structure and the spiral structure. In some approaches (e.g., Metal Jet Fusion), the union may be printed with binding agent (e.g., glue) to form a precursor object (e.g., “green part”). The precursor object may be heated in an oven to solidify the 3D lattice structure and the spiral structure.

In some examples, the apparatus may print multiple flow exchange structures (e.g., spiral structures) that transect the 3D lattice structure in a channel of the heat exchanger. For instance, the apparatus may print a second spiral structure that transects the 3D lattice structure in a channel of the heat exchanger.

In some examples, a dimension of a first scale of the spiral structure may be larger than a corresponding dimension of a second scale of the 3D lattice structure. For instance, a repetitive structure size of the spiral structure may be larger than a repetitive structure size of the 3D lattice structure. In some examples, a thickness of the spiral structure may be similar to or different from a thickness of the 3D lattice structure.

Some examples of the techniques described herein may provide approaches to produce many types of lattice structures and/or other heat exchange features. For instance, some of the manufacturing approaches described herein may be executed on a computing device and/or 3D printer, which may provide relatively low design and/or manufacturing costs. Some examples of the of the cooling lattice structures at smaller-scales and the flow exchange structures at larger-scales may be independent. For instance, a 3D lattice structure may be sized independently from a flow exchange structure. In some examples, perforations in fluid exchange structures may be positioned to facilitate removal of unprinted powder in a 3D printing procedure.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A heat exchanger, comprising:
a three-dimensional (3D) lattice structure; and
a spiral structure transecting the 3D lattice structure, wherein the spiral structure is to mix fluid to pass through the 3D lattice structure.

2. The heat exchanger of claim 1, wherein the heat exchanger is a single-flow heat exchanger.

3. The heat exchanger of claim 1, wherein a dimension of a first scale of the spiral structure is larger than a corresponding dimension of a second scale of the 3D lattice structure.

4. The heat exchanger of claim 1, further comprising a second spiral structure transecting the 3D lattice structure, wherein the second spiral structure is disposed adjacent to the spiral structure in a channel of the heat exchanger.

5. The heat exchanger of claim 1, wherein the 3D lattice structure repeats in multiple directions and the spiral structure repeats in one direction.

6. The heat exchanger of claim 1, wherein the 3D lattice structure and the spiral structure are manufactured concurrently via 3D printing.

7. The heat exchanger of claim 6, wherein the 3D lattice structure supports the spiral structure during manufacturing.

8. The heat exchanger of claim 6, wherein the 3D lattice structure and the spiral structure are a monolithic body.

9. The heat exchanger of claim 6, wherein the spiral structure is perforated to facilitate removal of unprinted material.

10. An apparatus, comprising:
a memory;
a processor in electronic communication with the memory, wherein the processor is to:
control a printhead to print a three-dimensional (3D) lattice structure; and
control the printhead to print a flow exchange structure transecting the 3D lattice structure, wherein the flow exchange structure is to mix fluid to pass through the 3D lattice structure.

11. The apparatus of claim 10, wherein the 3D lattice structure and the flow exchange structure are printed concurrently.

12. The apparatus of claim 11, wherein 3D lattice structure is to support the flow exchange structure during sintering.

13. A method, comprising:
determine a union between a geometrical representation of a three-dimensional (3D) lattice structure and a spiral structure; and
print a heat exchanger by printing the union between the geometrical representation of the 3D lattice structure and the spiral structure, wherein the spiral structure transects the 3D lattice structure.

14. The method of claim 13, further comprising printing a second spiral structure that transects the 3D lattice structure in a channel of the heat exchanger.

15. The method of claim 13, wherein a first scale of the spiral structure is larger than a second scale of the 3D lattice structure.
